(19) United States
(12) Patent Application Publication
(10) Pub. No.: US 2016/0108862 A1
(43) Pub. Date: Apr. 21, 2016

(54) HYDROGEN RICH EGR SYSTEM AND METHOD

(71) Applicant: INTERNATIONAL ENGINE INTELLECTUAL PROPERTY COMPANY, LLC, Lisle, IL (US)

(72) Inventors: Grzegorz Siuchta, Des Plaines, IL (US); Russell P. Zukouski, Bolingbrook, IL (US)

(73) Assignee: International Engine Intellectual Property Company, LLC, Lisle, IL (US)

(21) Appl. No.: 14/893,296

(22) PCT Filed: May 24, 2013
(86) PCT No.: PCT/US13/42738

§ 371 Date: Nov. 23, 2015

(51) Int. Cl. F02M 25/07

(52) U.S. Cl. CPC F02M 25/0742; F02M 25/0717; F02M 25/0723; F02M 25/0726; F02M 25/0752

(57) ABSTRACT

A system and method for hydrogen rich exhaust gas recirculation are provided. The system includes the addition of a supplemental injector injecting additional natural gas beyond the stoichiometric point into one of the engine cylinders. After combustion, the exhaust of the cylinder remains high in hydrogen. The exhaust is then routed through a hydrogen rich exhaust path to an exhaust gas recirculation mixer where is it mixed with natural gas and exhaust gas from the other cylinders. The resultant mixture is then routed to all of the cylinders of the engine for improved combustion due to the additional hydrogen.

### RELATED APPLICATIONS

This application makes reference to, claims priority to, and claims the benefit of U.S. Provisional Patent Application No. 61/594,698, which was filed on Feb. 3, 2012 and is entitled “Hydrogen Rich EGR System for Natural Gas Spark Ignited Engines.” The disclosure of the above-identified Provisional Patent Application is hereby incorporated by reference in its entirety.

### BACKGROUND

Currently, spark ignition (SI) natural gas engines run stoichiometric or close to stoichiometric Air/Fuel Ratio (AFR) with limited mixture dilution with Exhaust Gas Recirculation (EGR) due to very poor ignitability and flamability of Natural Gas fuel. Lower EGR levels reduce engine performance (Torque and Power) due to exhaust temperature limits and knock combustion. Low EGR levels also reduce engine efficiency because of lower compression ratio required to prevet knock combustion.

### SUMMARY

One or more embodiments provide a hydrogen rich exhaust gas recirculation system and method including the addition of a supplemental injector injecting additional natural gas beyond the stoichiometric point into one of the engine cylinders. After combustion, the exhaust of the cylinder remains high in hydrogen. The exhaust is then routed through a hydrogen rich exhaust path to an exhaust gas recirculation mixer where is it mixed with natural gas and exhaust gas from the other cylinders. The resultant mixture is then routed to all of the cylinders of the engine for improved combustion due to the additional hydrogen.

### BRIEF DESCRIPTION OF THE DRAWINGS

FIG. 1 illustrates a hydrogen-rich super EGR system for a natural gas spark ignition engine according to the present system and method.

### DETAILED DESCRIPTION

The present system and method significantly enhances combustion of very lean and/or highly diluted (with EGR) Natural Gas (NG) fuel mixtures thus enabling higher EGR levels for higher engine performance and efficiency.

Currently, majority of the NG Spark Ignited Engines in automotive applications run at or near stoichiometric AFR and a low level of EGR. This allows reliable combustion and application of a 3-way catalyst for emission compliance. However, lean combustion and/or higher EGR requires more complex, high spark energy ignition systems which in turn compromise spark plug durability. Conversely, lean combustion and/or higher EGR improves engine performance due to lower pumping losses and higher compression ratio.

The present EGR system takes advantage of Hydrogen fuel properties. More specifically, hydrogen is highly flammable with flame speed 6 times faster than Natural Gas combustion. This which makes the addition of hydrogen a significant ignition and combustion enhancement. On one embodiment, as further described below, a Hydrogen rich “Super EGR” from one of the cylinders of a 6 cylinder engine provides constantly 17% summand to the total EGR flow which is regulated by the second (stoichiometric) EGR path.

More specifically, currently, stoichiometric SI Natural Gas engines run a standard EGR loop. That is, stoichiometric exhaust gas (with no Hydrogen content) is fed thru the EGR control valve and optional EGR cooler. The fuel system typically includes one or more central feed NG injectors.

The proposed system and method adds to the existing EGR system a “super rich” loop. The “super rich” loop includes a rich mixture port with an enrichment injector in order to increase the fuel/air equivalence—in one embodiment to the level 1.2 to 1.4 for the one of the six cylinders. Hydrogen rich (in one embodiment 3% to 6%) EGR path is fed for all cylinders through the EGR cooler and EGR mixer.

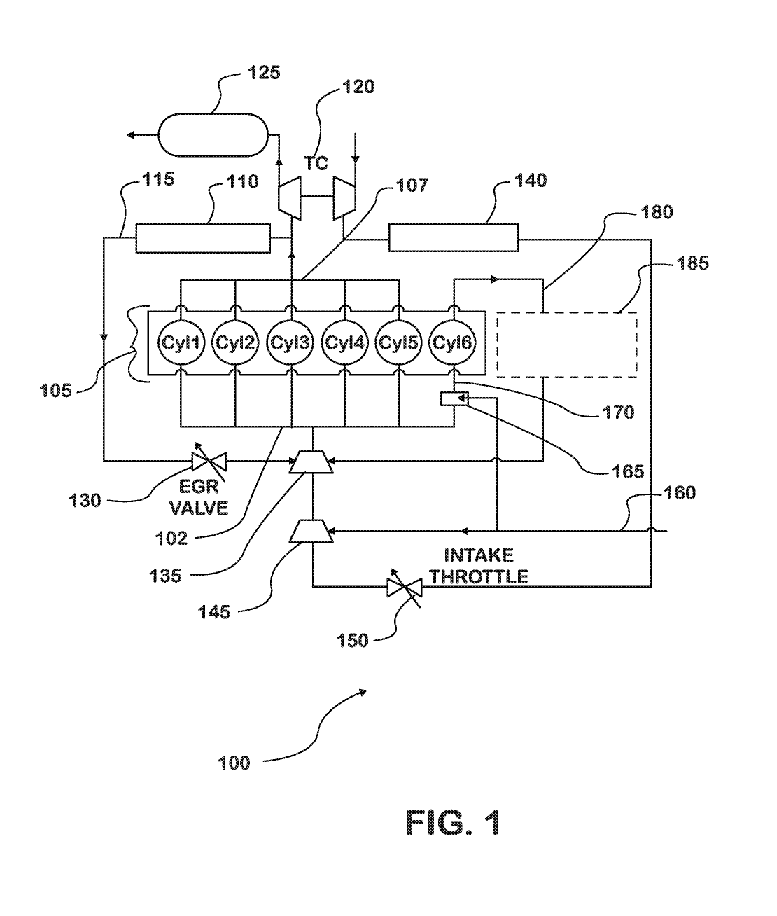

FIG. 1 illustrates a hydrogen-rich super EGR system 100 for a natural gas spark ignition engine according to the present system and method. FIG. 1 shows several standard engine components including a stoichiometric mixture path 102, several engine cylinders 105, a stoichiometric exhaust path 107, an EGR cooler 110, a main EGR path 115, a turbocharger 120, a three-way catalyst 125, an EGR valve 130, an EGR mixer 135, a charge air cooler 140, a natural gas main injector 145, and an intake throttle 150.

Additionally, FIG. 1 illustrates a natural gas fuel supply 160, a supplemental natural gas injector for cylinder 6 enrichment 165, a rich mixture port 170, a hydrogen-right EGR path 180, and an optional secondary EGR cooler 185.

In typical operation, natural gas is fed from the natural gas fuel supply 160 to the natural gas main injector 145. The natural gas then passes to the EGR mixer 135 where it is mixed with exhaust gas from the EGR valve 130. The natural gas and exhaust gas mixture is then provided to the cylinders 105 where it is combusted. The exhaust gas from the cylinders travels outward through the stoichiometric exhaust path where a portion of the exhaust gas is used to power the turbocharger 120 and then passes through the three-way catalyst 125. The remainder of the exhaust gas is recirculated to the EGR valve 130. The turbocharger 120 compresses intake air that is then passed to the charge air cooler 140 and into the natural gas main injector.

In addition to the typical EGR system, FIG. 1 shows that a portion of the natural gas fuel supply is now routed to the supplemental NG injector for cylinder six enrichment 165. Thus, the fuel entering cylinder sic is enriched considerably beyond the expected stoichiometric point. Consequently, after combustion of cylinder 6, the exhaust will be high in hydrogen and the resulting high-hydrogen exhaust gas of cylinder six is then recirculated to the remaining cylinders.

More specifically, from the supplemental natural gas injector 165, the supplemented fuel passes through the rich mixture port 170 and into cylinder six where the fuel is combusted. The exhaust of cylinder 6 is not routed through the stoichiometric exhaust path 107, but instead passes through a hydrogen-rich EGR path 180, and in one embodiment through a rich EGR path cooler 185 until it reaches the EGR mixer 135. At the EGR mixer 145, the exhaust from the hydrogen rich EGR path 180 is combined with the exhaust from the stoichiometric exhaust path 107 and natural gas from the natural gas main injector 145. The mixture is then provided to all of the six cylinders 105.

The addition of a secondary “super rich EGR loop” with high hydrogen content supports spark ignition and combustion of high EGR content and/or lean mixtures of Natural Gas and air. The rich EGR has 3% to 6% hydrogen content which generated in the rich combustion cylinder—by combustion of NG fuel/air with equivalence ratio in one embodiment in the range of 1.2 to 1.4. The enrichment—higher equivalence ration than 1.0 (stoichiometric)—is achieved by supplemental injection of NG fuel to the inlet port of one cylinder of a 6-cylinder engine. The whole exhaust flow of the dedicated cylinder is reverted to the inlet. Consequently, minimal EGR % is in one embodiment about ˜17%. The EGR control above 17% is realized by the addition of a standard EGR leg which in one embodiment includes EGR cooler and EGR valve.

The present system and method includes the advantages of higher compression ratio for better performance and cooler EGR, lower spark energy for better spark plug durability, reduction or elimination of knock combustion, and allowing high EGR rates (>17%) without increasing pumping losses, while providing positive or close to zero boost-back pressure.

Additionally, the present system and method may improve the application of a stoichiometric combustion NG engine with a 3-way catalyst, which may be an inexpensive way to meet EPA/CARB 2010 On Highway emission standards.

1. A hydrogen-rich EGR system for a natural gas spark ignition engine, the system including:
a supplemental injector injecting additional natural gas into a fuel supply for at least one cylinder of an engine, wherein the additional natural gas exceeds the stoichiometric point of combustion of the at least one cylinder;
a hydrogen rich exhaust path from the output of the at least one cylinder; and
an exhaust gas recirculation mixer, wherein the hydrogen rich exhaust path transmit hydrogen rich exhaust from the at least one cylinder to the exhaust gas recirculation mixer, wherein the exhaust gas recirculation mixer mixes the hydrogen rich exhaust with natural gas and exhaust from at least one other cylinder of the engine and provides the resulting mixture to a plurality of cylinders of the engine.

2. The system of claim 1 wherein the hydrogen rich exhaust path includes a rich exhaust gas recirculation path cooler.

3. The system of claim 1 wherein the addition of natural gas by the supplemental injector results in a natural gas fuel/air equivalence ratio in the range of 1.2 to 1.4.

4. A method for hydrogen-rich exhaust gas recirculation, the method including:
injecting additional natural gas into a fuel supply for at least one cylinder of an engine, wherein the additional natural gas exceeds the stoichiometric point of combustion of the at least one cylinder;
passing the hydrogen rich exhaust of the at least one cylinder into a hydrogen rich exhaust path for transmission to an exhaust gas recirculation mixer;
mixing, at the exhaust gas recirculation mixer, the hydrogen rich exhaust gas with natural gas and exhaust from at least one other cylinder of the engine; and
providing the resulting mixture to a plurality of cylinders of the engine.

5. The method of claim 4 further including passing the hydrogen rich exhaust through a rich exhaust gas recirculation path cooler.

6. The method of claim 4 wherein the injecting of additional natural gas results in a natural gas fuel/air equivalence ratio in the range of 1.2 to 1.4.
